(19) United States
(12) Patent Application Publication
(10) Pub. No.: US 2025/0389933 A1
(43) Pub. Date: Dec. 25, 2025

(54) OPTICAL IMAGING LENS SYSTEM

(71) Applicant: SAMSUNG ELECTRO-MECHANICS CO., LTD., Suwon-si (KR)

(72) Inventors: Kum Ho KIM, Suwon-si (KR); Dong Hyuk JANG, Suwon-si (KR); Dong Shin YANG, Suwon-si (KR); Ji Su LEE, Suwon-si (KR); Se Ryun BYUN, Suwon-si (KR)

(73) Assignee: SAMSUNG ELECTRO-MECHANICS CO., LTD., Suwon-si (KR)

(21) Appl. No.: 19/059,928

(22) Filed: Feb. 21, 2025

(30) Foreign Application Priority Data
Jun. 25, 2024 (KR) 10-2024-0082609

(51) Int. Cl. G02B 13/00; G02B 9/64

(52) U.S. Cl. CPC G02B 13/0045; G02B 9/64

(57) ABSTRACT

An optical imaging lens system includes a first lens, a second lens, a third lens, a fourth lens, a fifth lens, a sixth lens, and a seventh lens, arranged in order from an object side, wherein the first lens has a convex image-side surface, and the sixth lens has a concave object-side surface, and the following conditional expression is satisfied: (TTL/IMH)*Fno<1.7, where TTL is a distance on an optical axis from an object-side surface of the first lens to an imaging plane and IMH is a diagonal length of the imaging plane.

### CROSS-REFERENCE TO RELATED APPLICATIONS

This application claims the benefit under 35 USC 119 (a) of Korean Patent Application No. 10-2024-0082609 filed on Jun. 25, 2024, in the Korean Intellectual Property Office, the entire disclosure of which is incorporated herein by reference for all purposes.

### BACKGROUND

### 1. Field

The present disclosure relates to an optical imaging lens system.

### 2. Description of the Background

Recently, a performance of cameras mounted in mobile devices has been gradually improving.

For example, cameras for mobile devices are commonly being equipped with high-resolution image sensors and optical systems are being developed to be suitable for this.

Meanwhile, in general, as the size of the image sensor increases, a total length of the optical system also increases. However, as slimming is essential for mobile devices, the development of a slim yet high-performance optical system is required.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging lens system includes a first lens, a second lens, a third lens, a fourth lens, a fifth lens, a sixth lens, and a seventh lens, arranged in order from an object side, wherein the first lens has a convex image-side surface, and the sixth lens has a concave object-side surface, and the following conditional expression is satisfied: (TTL/IMH)*Fno<1.71, where TTL is a distance on an optical axis from an object-side surface of the first lens to an imaging plane and IMH is a diagonal length of the imaging plane.

The sixth lens may have a convex image-side surface.

The following conditional expression may be satisfied: L6R1/CT6<−6, where L6R1 is a radius of curvature of the object-side surface of the sixth lens, and CT6 is a thickness on the optical axis of the sixth lens.

The following conditional expression may be satisfied: 2<L6R1/L6R2, where L6R1 is a radius of curvature of the object-side surface of the sixth lens, and L6R2 is a radius of curvature of an image-side surface of the sixth lens.

The fourth lens may have a convex object-side surface.

The following conditional expression may be satisfied: 15<v1−v2<40, where v1 is an Abbe number of the first lens, and v2 is an Abbe number of the second lens.

The following conditional expression may be satisfied: 0<v1−v7<40, where v1 is an Abbe number of the first lens, and v7 is an Abbe number of the seventh lens.

The fifth lens may have negative refractive power and a concave image-side surface.

The sixth lens may have positive refractive power, and the seventh lens may have negative refractive power.

In another general aspect, an optical imaging lens system includes a first lens having negative refractive power and a convex image-side surface, a second lens having positive refractive power, a third lens having positive refractive power, a fourth lens having positive refractive power, a fifth lens having refractive power, a sixth lens having positive refractive power, and a seventh lens having refractive power, wherein the first lens to the seventh lens are arranged in order from an object side, and the following conditional expression is satisfied L6R1/CT6<−6, where L6R1 is a radius of curvature of an object-side surface of the sixth lens, and CT6 is a thickness on an optical axis of the sixth lens.

The fifth lens and the seventh lens may each have negative refractive power.

The following conditional expression may be satisfied: TTL/IMH<0.86, where TTL is a distance on the optical axis from an object-side surface of the first lens to an imaging plane, and IMH is a diagonal length of the imaging plane.

The following conditional expression may be satisfied: 50<FOV/f (unit: °/mm), where FOV is a field of view of the optical imaging lens system, and f is a total focal length of the optical imaging lens system.

The following conditional expression may be satisfied: 25<v1-v5<45, where v1 is an Abbe number of the first lens, and v5 is an Abbe number of the fifth lens.

The fifth lens may have a concave image-side surface.

Other features and aspects will be apparent from the following detailed description, the drawings, and the claims.

### BRIEF DESCRIPTION OF DRAWINGS

FIG. 1A is a configuration diagram of an optical imaging lens system according to a first embodiment of the present disclosure.

FIG. 1B is a graph illustrating aberration characteristics of the optical imaging lens system illustrated in FIG. 1A.

FIG. 2A is a configuration diagram of an optical imaging lens system according to a second embodiment of the present disclosure.

FIG. 2B is a graph illustrating aberration characteristics of the optical imaging lens system illustrated in FIG. 2A.

FIG. 3A is a configuration diagram of an optical imaging lens system according to a third embodiment of the present disclosure.

FIG. 3B is a graph illustrating aberration characteristics of the optical imaging lens system illustrated in FIG. 3A.

FIG. 4A is a configuration diagram of an optical imaging lens system according to a fourth embodiment of the present disclosure.

FIG. 4B is a graph illustrating aberration characteristics of the optical imaging lens system illustrated in FIG. 4A.

FIG. 5A is a configuration diagram of an optical imaging lens system according to a fifth embodiment of the present disclosure.

FIG. 5B is a graph illustrating aberration characteristics of the optical imaging lens system illustrated in FIG. 5A.

FIG. 6A is a configuration diagram of an optical imaging lens system according to a sixth embodiment of the present disclosure.

FIG. 6B is a graph illustrating aberration characteristics of the optical imaging lens system illustrated in FIG. 6A.

FIG. 7A is a configuration diagram of an optical imaging lens system according to a seventh embodiment of the present disclosure.

FIG. 7B is a graph illustrating aberration characteristics of the optical imaging lens system illustrated in FIG. 7A.

FIG. 8A is a configuration diagram of an optical imaging lens system according to an eighth embodiment of the present disclosure.

FIG. 8B is a graph illustrating aberration characteristics of the optical imaging lens system illustrated in FIG. 8A.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure aims to provide a slim optical imaging lens system capable of capturing high-resolution images.

In addition, the present disclosure aims to provide an ultra-wide-angle shooting lens system advantageous for recording in a dark environment.

In the present disclosure, a first lens refers to a lens closest to an object side, and a seventh lens refers to a lens closest to an image sensor side (or an image side).

Also, in the descriptions of a shape of a lens, a configuration in which one surface is convex indicates that a paraxial region of the one surface is convex, and a configuration in which one surface is concave indicates that a paraxial region of the one surface is concave. A paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid. Thus, even when it is described that one surface of a lens is convex, an edge portion of the lens may be concave. Similarly, even when it is described that one surface of a lens is concave, an edge portion of the lens may be convex.

In the present disclosure, all parameters related to length, including a radius of curvature, a thickness, a distance, and a focal length of the lens, are all in millimeters (mm), and a unit of field of view is degrees (°).

An optical imaging lens system according to an embodiment of the present disclosure may include seven lenses. For example, an optical imaging lens system may include a first lens, a second lens, a third lens, a fourth lens, a fifth lens, a sixth lens, and a seventh lens, arranged in order from an object side.

However, the optical imaging lens system according to an embodiment of the present disclosure may not be comprised of only seven lenses.

For example, the optical imaging lens system may further include an image sensor converting an incident image of a subject into an electrical signal.

In addition, the optical imaging lens system may further include an infrared blocking filter (hereinafter referred to as a “filter”) blocking light within the infrared range among the light incident on the image sensor. For example, the filter may be disposed between the seventh lens and the image sensor.

Additionally, the optical imaging lens system may further include a stop for controlling an amount of light. For example, the stop may be disposed between the second lens and the third lens.

The optical imaging lens system according to an embodiment of the present disclosure may include lenses formed of a plastic material. For example, the first to seventh lenses may all be formed of a plastic material.

The optical imaging lens system according to an embodiment of the present disclosure may include aspherical lenses. For example, at least one surface of each of the first to seventh lenses may be an aspherical surface. As a further example, the first to seventh lenses may have aspherical surfaces on both an object-side surface and an image-side surface.

The aspherical surface of each lens may be expressed by the following Conditional expression 1.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad [ Conditional expression 1 ]$$

In Conditional expression 1, c is a curvature (reciprocal of a radius of curvature) of a lens, K is a conic constant, Y is a distance from certain point on an aspherical surface of the lens to an optical axis, A to H, J, and L to P are aspherical coefficients, and Z (SAG) is a distance in an optical axis direction between certain points on the aspherical surface of the lens and a vertex of the corresponding aspherical surface.

The optical imaging lens system according to an embodiment of the present disclosure may be an ultra-wide-angle lens system capable of capturing bright images even in a dark environment. For example, a field of view of the optical imaging lens system may be 115° or more, and Fno may be less than 2.0.

An optical imaging lens system according to an embodiment of the present disclosure may satisfy the following conditional expressions.

$$( TTL / IMH ) ⋆ Fno < 1.71 \qquad [ Conditional expression 1 ]$$

$$f / EPD \leq 2.0 \qquad [ Conditional expression 2 ]$$

$$15 < v 1 - v 2 < 40 \qquad [ Conditional expression 3 ]$$

$$25 < v 1 - v 5 < 45 \qquad [ Conditional expression 4 ]$$

$$0 < v 1 - v 7 < 40 \qquad [ Conditional expression 5 ]$$

$$TTL / IMH < 0.86 \qquad [ Conditional expression 6 ]$$

$$50 < F O V / f ( unit : ° / mm ) \qquad [ Conditional expression 7 ]$$

$$L 6 R 1 / CT 6 < - 6 \qquad [ Conditional expression 8 ]$$

$$2 < L 6 R 1 / L 6 R 2 \qquad [ Conditional expression 9 ]$$

$$2.3 < L 1 R 1 / L 2 R 2 < 3.3 \qquad [ Conditional expression 10 ]$$

In [Conditional expression 1], [Conditional expression 2], and [Conditional expression 6], TTL is a distance on an optical axis from an object-side surface of the first lens to an imaging plane, IMH is a diagonal length of the imaging plane, f is a focal length of the optical imaging lens system, EPD is a diameter of an entrance pupil, and Fno is a numerical value representing brightness of the optical imaging lens system calculated by f/EPD of [Conditional expression 2]. [Conditional expression 2] is a condition defining the brightness of the optical imaging lens system, and when [Conditional expression 2] is satisfied, the required level of brightness may be implemented. [Conditional expression 6] is an index of miniaturization of the optical imaging lens system, and when [Conditional expression 6] is satisfied, the miniaturization goal may be implemented. Furthermore, when [Conditional expression 1] is satisfied, it may correspond to an optical imaging lens system having a miniaturization purpose and a required level of brightness.

In [Conditional expression 3], [Conditional expression 4], and [Conditional expression 5], v1 is an Abbe number of the first lens, v2 is an Abbe number of the second lens, v5 is an Abbe number of the fifth lens, and v7 is an Abbe number of the seventh lens. When [Conditional expression 3], [Conditional expression 4], and [Conditional expression 5] are satisfied, the chromatic aberration of the optical imaging lens system may be minimized.

In [Conditional expression 7], FOV is a field of view of the optical imaging lens system, and f is a focal length of the optical imaging lens system. When [Conditional expression 7] is satisfied, the optical imaging lens system may correspond to a (ultra) wide-angle lens system.

In [Conditional expression 8] and [Conditional expression 9], L6R1 is a radius of curvature of an object-side surface of the sixth lens, L6R2 is a radius of curvature of an image-side surface of the sixth lens, and CT6 is a thickness on the optical axis of the sixth lens. [Conditional expression 8] and [Conditional expression 9] may be shape-related conditions of the sixth lens for removing stray light, and when [Conditional expression 8] and [Conditional expression 9] are satisfied, the flare phenomenon may be prevented.

In [Conditional expression 10], L1R1 is an effective radius of an object-side surface of the first lens, and L2R2 is an effective radius of an image-side surface of the second lens. [Conditional expression 10] is a shape-related condition of the first lens for implementing a (ultra) wide-angle lens system, and when [Conditional expression 10] is satisfied, the optical imaging lens system may correspond to a (ultra) wide-angle lens system.

### 1st Embodiment

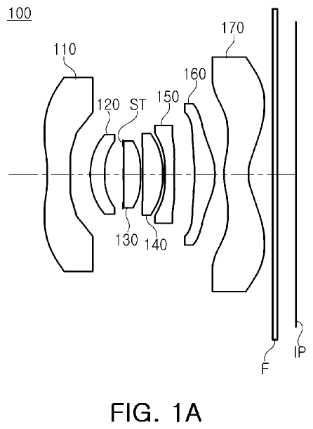

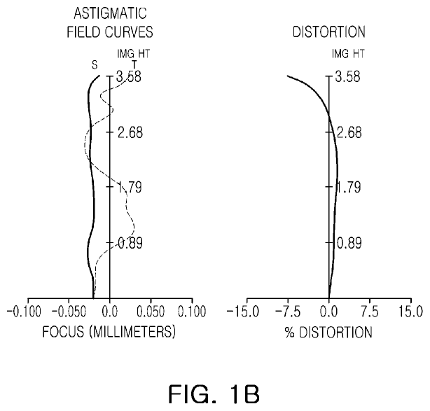

FIG. 1A is a configuration diagram of an optical imaging lens system according to a first embodiment of the present disclosure, and FIG. 1B is a graph illustrating aberration characteristics of the optical imaging lens system illustrated in FIG. 1A.

An optical imaging lens system 100 according to the first embodiment of the present disclosure may include a first lens 110, a second lens 120, a third lens 130, a fourth lens 140, a fifth lens 150, a sixth lens 160, and a seventh lens 170.

In addition, the optical imaging lens system 100 may include a filter (F) disposed on an image side of the seventh lens 170, an imaging plane (IP) where an image is formed as part of an image sensor, and a stop (ST) disposed between the second lens 120 and the third lens 130 to control the amount of light.

Where f of the optical imaging lens system 100 according to the first embodiment of the present disclosure is 2.214 mm, IMH is 7.150 mm, EPD is 1.119 mm, and FOV is 120.100°.

The characteristics of each lens of the optical imaging lens system 100 according to the first embodiment of the present disclosure are as illustrated in Table 1 below.

TABLE 1

| Surface | Compo- | Curvature | Thickness/ | Refractive | Abbe | Focal |
|---|---|---|---|---|---|---|
| No. | nent | Radius | Distance | Index | No. | Length |
| Object | | Infinity | Infinity | | | |
| S1 | | Infinity | 0.091 | | | |
| S2 | 1st Lens | −2.381 | 0.562 | 1.546 | 56.0 | −4.934 |
| S3 | | −22.122 | 0.487 | | | |
| S4 | 2nd Lens | 1.717 | 0.352 | 1.620 | 25.9 | 12.156 |
| S5 | | 2.049 | 0.449 | | | |
| S6 | STOP | Infinity | 0.019 | | | |
| S7 | 3rd Lens | 7.612 | 0.417 | 1.546 | 56.0 | 5.778 |
| S8 | | −5.289 | 0.050 | | | |
| S9 | 4th Lens | 10.399 | 0.498 | 1.546 | 56.0 | 2.729 |
| S10 | | −1.71 | 0.050 | | | |
| S11 | 5th Lens | −4.047 | 0.230 | 1.679 | 19.2 | −4.443 |
| S12 | | 12.109 | 0.500 | | | |
| S13 | 6th Lens | −3.408 | 0.500 | 1.546 | 56.0 | 4.083 |
| S14 | | −1.418 | 0.224 | | | |
| S15 | 7th Lens | 1.511 | 0.600 | 1.571 | 37.4 | −6.256 |
| S16 | | 0.908 | 0.600 | | | |
| S17 | Filter | Infinity | 0.110 | 1.518 | 64.2 | |
| S18 | Imaging | Infinity | 0.463 | | | |
| | Plane | | | | | |

According to the first embodiment of the present disclosure, the first lens 110 may have negative refractive power. In addition, the first lens 110 may have a concave object-side surface S2 and a convex image-side surface S3 in the paraxial region.

The second lens 120 may have positive refractive power. In addition, the second lens 120 may have a convex object-side surface S4 and a concave image-side surface S5 in the paraxial region.

The third lens 130 may have positive refractive power. In addition, both an object-side surface S7 and an image-side surface S8 of the third lens 130 may have a convex shape in the paraxial region.

The fourth lens 140 may have positive refractive power. In addition, both an object-side surface S9 and an image-side surface S10 of the fourth lens 140 may have a convex shape in the paraxial region.

The fifth lens 150 may have negative refractive power. In addition, both an object-side surface S11 and an image-side surface S12 of the fifth lens 150 may have a concave shape in the paraxial region.

The sixth lens 160 may have positive refractive power. In addition, the sixth lens 160 may have a concave object-side surface S13 and a convex image-side surface S14 in the paraxial region.

The seventh lens 170 may have negative refractive power. In addition, the seventh lens 170 may have a convex object-side surface S15 and a concave image-side surface S16 in the paraxial region.

According to the first embodiment of the present disclosure, both the object-side surface and the image-side surface of the first lens 110 to the seventh lens 170 may be aspherical.

Aspherical coefficients of each lens of the optical imaging lens system 100 according to the first embodiment of the present disclosure are as illustrated in Table 2 below.

TABLE 2

| | S2 | S3 | S4 | S5 | S7 |
|---|---|---|---|---|---|
| K | −1.027E+01 | 9.373E+01 | −1.785E+00 | 4.896E+00 | 8.010E+01 |
| A | 1.696E−01 | 2.748E−01 | 1.947E−01 | −3.302E−02 | −1.237E−01 |
| B | −1.788E−01 | −2.269E−03 | −1.240E+00 | 2.381E+00 | −2.621E−01 |
| C | 1.896E−01 | −1.206E+00 | 1.300E+01 | −3.914E+01 | 1.509E+01 |
| D | −1.748E−01 | 5.185E+00 | −9.735E+01 | 4.034E+02 | −3.856E+02 |
| E | 1.290E−01 | −1.380E+01 | 5.197E+02 | −2.810E+03 | 5.560E+03 |
| F | −7.286E−02 | 2.578E+01 | −2.003E+03 | 1.365E+04 | −5.165E+04 |
| G | 3.086E−02 | −3.482E+01 | 5.642E+03 | −4.641E+04 | 3.277E+05 |
| H | −9.699E−03 | 3.428E+01 | −1.168E+04 | 1.089E+05 | −1.462E+06 |
| J | 2.238E−03 | −2.454E+01 | 1.770E+04 | −1.680E+05 | 4.636E+06 |
| L | −3.721E−04 | 1.261E+01 | −1.938E+04 | 1.477E+05 | −1.040E+07 |
| M | 4.321E−05 | −4.523E+00 | 1.491E+04 | −2.640E+04 | 1.612E+07 |
| N | −3.309E−06 | 1.073E+00 | −7.637E+03 | −8.677E+04 | −1.644E+07 |
| O | 1.494E−07 | −1.510E−01 | 2.337E+03 | 8.718E+04 | 9.912E+06 |
| P | −2.989E−09 | 9.527E−03 | −3.230E+02 | −2.753E+04 | −2.677E+06 |

| | S8 | S9 | S10 | S11 | S12 |
|---|---|---|---|---|---|
| K | 1.892E+01 | 2.993E+01 | −1.029E+00 | 7.141E+00 | 8.438E+01 |
| A | −1.908E−01 | −1.735E−01 | 8.849E−01 | 6.671E−01 | 8.261E−02 |
| B | −4.654E+00 | −9.159E−01 | −7.972E+00 | −7.014E+00 | −1.820E+00 |
| C | 7.472E+01 | 1.422E+01 | 5.275E+01 | 4.070E+01 | 9.142E+00 |
| D | −8.000E+02 | −1.368E+02 | −3.009E+02 | −2.120E+02 | −3.826E+01 |
| E | 6.140E+03 | 9.332E+02 | 1.388E+03 | 9.537E+02 | 1.304E+02 |
| F | −3.424E+04 | −4.444E+03 | −4.948E+03 | −3.431E+03 | −3.395E+02 |
| G | 1.401E+05 | 1.504E+04 | 1.337E+04 | 9.451E+03 | 6.590E+02 |
| H | −4.230E+05 | −3.671E+04 | −2.709E+04 | −1.948E+04 | −9.469E+02 |
| J | 9.375E+05 | 6.485E+04 | 4.059E+04 | 2.951E+04 | 9.987E+02 |
| L | −1.505E+06 | −8.215E+04 | −4.412E+04 | −3.220E+04 | −7.612E+02 |
| M | 1.700E+06 | 7.272E+04 | 3.371E+04 | 2.453E+04 | 4.071E+02 |
| N | −1.279E+06 | −4.269E+04 | −1.712E+04 | −1.236E+04 | −1.446E+02 |
| O | 5.755E+05 | 1.492E+04 | 5.181E+03 | 3.693E+03 | 3.063E+01 |
| P | −1.170E+05 | −2.351E+03 | −7.063E+02 | −4.955E+02 | −2.923E+00 |

| | S13 | S14 | S15 | S16 |
|---|---|---|---|---|
| K | 2.814E+00 | −2.048E+00 | −3.256E+00 | −9.441E−01 |
| A | 2.387E−01 | −6.692E−02 | −3.890E−01 | −5.729E−01 |
| B | −3.954E−01 | 2.316E−01 | 4.508E−01 | 5.813E−01 |
| C | 8.118E−01 | 5.018E−02 | −4.760E−01 | −5.141E−01 |
| D | −1.129E+00 | −8.807E−01 | 4.677E−01 | 3.536E−01 |
| E | 3.062E−01 | 2.042E+00 | −4.152E−01 | −1.847E−01 |
| F | 2.215E+00 | −2.767E+00 | 3.034E−01 | 7.275E−02 |
| G | −5.139E+00 | 2.485E+00 | −1.690E−01 | −2.155E−02 |
| H | 6.233E+00 | −1.549E+00 | 6.888E−02 | 4.783E−03 |
| J | −4.903E+00 | 6.820E−01 | −2.014E−02 | −7.885E−04 |
| L | 2.626E+00 | −2.107E−01 | 4.150E−03 | 9.495E−05 |
| M | −9.556E−01 | 4.416E−02 | −5.874E−04 | −8.104E−06 |
| N | 2.266E−01 | −5.837E−03 | 5.428E−05 | 4.642E−07 |
| O | −3.161E−02 | 4.173E−04 | −2.949E−06 | −1.601E−08 |
| P | 1.969E−03 | −1.071E−05 | 7.146E−08 | 2.511E−10 |

### 2nd Embodiment

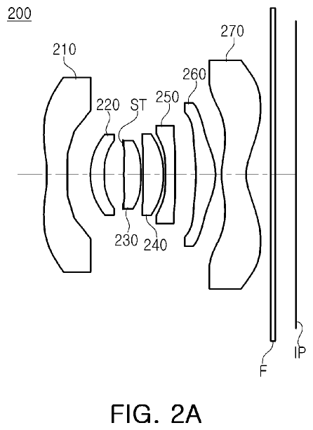

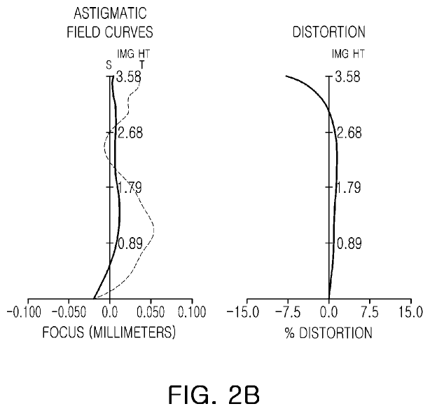

FIG. 2A is a configuration diagram of an optical imaging lens system according to a second embodiment of the present disclosure, and FIG. 2B is a graph illustrating aberration characteristics of the optical imaging lens system illustrated in FIG. 2A.

An optical imaging lens system 200 according to the second embodiment of the present disclosure may include a first lens 210, a second lens 220, a third lens 230, a fourth lens 240, a fifth lens 250, a sixth lens 260, and a seventh lens 270.

In addition, the optical imaging lens system 200 may include a filter (F) disposed on an image side of the seventh lens 270, an imaging plane (IP) where an image is formed as part of an image sensor, and a stop (ST) disposed between the second lens 220 and the third lens 230 to control the amount of light.

Where f of the optical imaging lens system 200 according to the second embodiment of the present disclosure is 2.220 mm, IMH is 7.150 mm, EPD is 1.122 mm, and FOV is 120.010°.

The characteristics of each lens of the optical imaging lens system 200 according to the second embodiment of the present disclosure are as illustrated in Table 3 below.

TABLE 3

| Surface | Compo- | Curvature | Thickness/ | Refractive | Abbe | Focal |
|---|---|---|---|---|---|---|
| No. | nent | Radius | Distance | Index | No. | Length |
| Object | | Infinity | Infinity | | | |
| S1 | | Infinity | 0.093 | | | |
| S2 | 1st Lens | −2.289 | 0.504 | 1.546 | 56.0 | −4.651 |
| S3 | | −24.824 | 0.563 | | | |
| S4 | 2nd Lens | 1.642 | 0.337 | 1.620 | 25.9 | 10.293 |
| S5 | | 2.036 | 0.463 | | | |
| S6 | STOP | Infinity | 0.026 | | | |
| S7 | 3rd Lens | 8.283 | 0.414 | 1.546 | 56.0 | 5.753 |
| S8 | | −4.976 | 0.050 | | | |
| S9 | 4th Lens | 10.399 | 0.503 | 1.546 | 56.0 | 2.701 |
| S10 | | −1.691 | 0.050 | | | |
| S11 | 5th Lens | −4.076 | 0.230 | 1.679 | 19.2 | −4.412 |
| S12 | | 11.550 | 0.513 | | | |
| S13 | 6th Lens | −3.386 | 0.476 | 1.546 | 56.0 | 4.114 |
| S14 | | −1.418 | 0.159 | | | |
| S15 | 7th Lens | 1.596 | 0.600 | 1.571 | 37.4 | −5.803 |
| S16 | | 0.930 | 0.600 | | | |
| S17 | Filter | Infinity | 0.110 | 1.518 | 64.2 | |
| S18 | Imaging | Infinity | 0.510 | | | |
| | Plane | | | | | |

According to the second embodiment of the present disclosure, the first lens 210 may have negative refractive power. In addition, the first lens 210 may have a concave object-side surface S2 and a convex image-side surface S3 in the paraxial region.

The second lens 220 may have positive refractive power. In addition, the second lens 220 may have a convex object-side surface S4 and a concave image-side surface S5 in the paraxial region.

The third lens 230 may have positive refractive power. In addition, both an object-side surface S7 and an image-side surface S8 of the third lens 230 may have a convex shape in the paraxial region.

The fourth lens 240 may have positive refractive power. In addition, both an object-side surface S9 and an image-side surface S10 of the fourth lens 240 may have a convex shape in the paraxial region.

The fifth lens 250 may have negative refractive power. In addition, both an object-side surface S11 and an image-side surface S12 of the fifth lens 250 may have a concave shape in the paraxial region.

The sixth lens 260 may have positive refractive power. In addition, the sixth lens 260 may have a concave object-side surface S13 and a convex image-side surface S14 in the paraxial region.

The seventh lens 270 may have negative refractive power. In addition, the seventh lens 270 may have a convex object-side surface S15 and a concave image-side surface S16 in the paraxial region.

According to the second embodiment of the present disclosure, both the object-side surface and the image-side surface of the first lens 210 to the seventh lens 270 may be aspherical.

The aspherical coefficients of each lens of the optical imaging lens system 200 according to the second embodiment of the present disclosure are as illustrated in Table 4 below.

TABLE 4

| | S2 | S3 | S4 | S5 | S7 |
|---|---|---|---|---|---|
| K | −1.053E+01 | 5.532E+01 | −2.243E+00 | 4.742E+00 | 7.930E+01 |
| A | 1.816E−01 | 2.896E−01 | 1.374E−01 | 4.046E−03 | 1.189E−02 |
| B | −2.080E−01 | −1.215E−01 | −2.902E−01 | 6.062E−01 | −4.867E+00 |
| C | 2.343E−01 | −7.546E−01 | 5.844E−01 | −2.158E+00 | 1.063E+02 |
| D | −2.233E−01 | 3.820E+00 | 1.327E+01 | −6.993E+01 | −1.541E+03 |
| E | 1.673E−01 | −1.040E+01 | −1.526E+02 | 1.188E+03 | 1.535E+04 |
| F | −9.528E−02 | 1.906E+01 | 8.444E+02 | −9.683E+03 | −1.088E+05 |
| G | 4.068E−02 | −2.470E+01 | −2.933E+03 | 5.019E+04 | 5.587E+05 |
| H | −1.293E−02 | 2.305E+01 | 6.916E+03 | −1.792E+05 | −2.096E+06 |
| J | 3.029E−03 | −1.553E+01 | −1.139E+04 | 4.524E+05 | 5.736E+06 |
| L | −5.143E−04 | 7.468E+00 | 1.315E+04 | −8.086E+05 | −1.130E+07 |
| M | 6.140E−05 | −2.498E+00 | −1.045E+04 | 1.002E+06 | 1.559E+07 |
| N | −4.874E−06 | 5.515E−01 | 5.443E+03 | −8.191E+05 | −1.427E+07 |
| O | 2.304E−07 | −7.212E−02 | −1.676E+03 | 3.973E+05 | 7.772E+06 |
| P | −4.898E−09 | 4.226E−03 | 2.314E+02 | −8.663E+04 | −1.904E+06 |

| | S8 | S9 | S10 | S11 | S12 |
|---|---|---|---|---|---|
| K | 1.902E+01 | 2.993E+01 | −8.015E−01 | 5.488E+00 | 9.117E+01 |
| A | −2.024E−01 | −1.735E−01 | 7.915E−01 | 5.068E−01 | 3.818E−02 |
| B | −4.975E+00 | −9.159E−01 | −6.802E+00 | −4.692E+00 | −1.696E+00 |
| C | 8.495E+01 | 1.422E+01 | 4.312E+01 | 1.757E+01 | 9.962E+00 |
| D | −9.300E+02 | −1.368E+02 | −2.370E+02 | −3.845E+01 | −4.706E+01 |
| E | 7.120E+03 | 9.332E+02 | 1.054E+03 | 1.600E+01 | 1.740E+02 |
| F | −3.908E+04 | −4.444E+03 | −3.628E+03 | 2.148E+02 | −4.792E+02 |
| G | 1.564E+05 | 1.504E+04 | 9.473E+03 | −8.371E+02 | 9.716E+02 |
| H | −4.601E+05 | −3.671E+04 | −1.855E+04 | 1.711E+03 | −1.447E+03 |
| J | 9.934E+05 | 6.485E+04 | 2.690E+04 | −2.257E+03 | 1.575E+03 |
| L | −1.555E+06 | −8.215E+04 | −2.933E+04 | 2.016E+03 | −1.235E+03 |
| M | 1.714E+06 | 7.272E+04 | 2.100E+04 | −1.219E+03 | 6.789E+02 |
| N | −1.262E+06 | −4.269E+04 | −1.036E+04 | 4.819E+02 | −2.480E+02 |
| O | 5.563E+05 | 1.492E+04 | 3.052E+03 | −1.133E+02 | 5.405E+01 |
| P | −1.110E+05 | −2.351E+03 | −4.057E+02 | 1.211E+01 | −5.318E+00 |

| | S13 | S14 | S15 | S16 |
|---|---|---|---|---|
| K | 2.648E+00 | −2.048E+00 | −3.124E+00 | −9.427E−01 |
| A | 2.684E−01 | −6.692E−02 | −4.518E−01 | −5.897E−01 |
| B | −7.289E−01 | 2.316E−01 | 5.899E−01 | 6.305E−01 |
| C | 2.239E+00 | 5.018E−02 | −7.176E−01 | −5.934E−01 |
| D | −5.352E+00 | −8.807E−01 | 8.043E−01 | 4.383E−01 |
| E | 9.434E+00 | 2.042E+00 | −7.791E−01 | −2.475E−01 |
| F | −1.236E+01 | −2.767E+00 | 5.993E−01 | 1.059E−01 |
| G | 1.212E+01 | 2.485E+00 | −3.464E−01 | −3.422E−02 |
| H | −8.943E+00 | −1.549E+00 | 1.463E−01 | 8.307E−03 |
| J | 4.964E+00 | 6.820E−01 | −4.444E−02 | −1.501E−03 |
| L | −2.053E+00 | −2.107E−01 | 9.556E−03 | 1.986E−04 |
| M | 6.189E−01 | 4.416E−02 | −1.415E−03 | −1.866E−05 |
| N | −1.299E−01 | −5.837E−03 | 1.372E−04 | 1.178E−06 |
| O | 1.714E−02 | 4.173E−04 | −7.838E−06 | −4.477E−08 |
| P | −1.077E−03 | −1.071E−05 | 1.999E−07 | 7.744E−10 |

### 3rd Embodiment

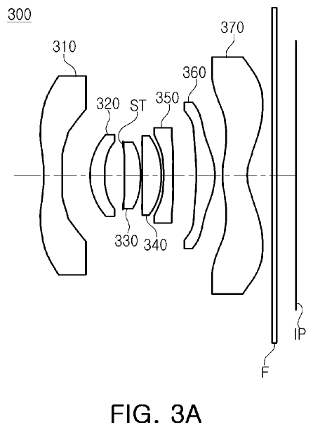

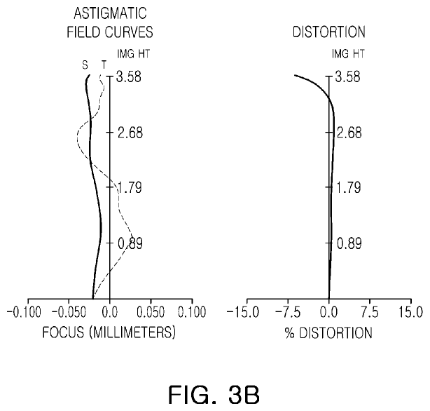

FIG. 3A is a configuration diagram of an optical imaging lens system according to a third embodiment of the present disclosure, and FIG. 3B is a graph illustrating aberration characteristics of the optical imaging lens system illustrated in FIG. 3A.

An optical imaging lens system 300 according to the third embodiment of the present disclosure may include a first lens 310, a second lens 320, a third lens 330, a fourth lens 340, a fifth lens 350, a sixth lens 360, and a seventh lens 370.

In addition, the optical imaging lens system 300 may include a filter (F) disposed on an image side of the seventh lens 370, an imaging plane (IP) where an image is formed as part of an image sensor, and a stop (ST) disposed between the second lens 320 and the third lens 330 to control the amount of light.

Where f of the optical imaging lens system 300 according to the third embodiment of the present disclosure is 2.184 mm, IMH is 7.150 mm, EPD is 1.103 mm, and FOV is 120.090°.

The characteristics of each lens of the optical imaging lens system 300 according to the third embodiment of the present disclosure are as illustrated in Table 5 below.

TABLE 5

| Surface | Compo- | Curvature | Thickness/ | Refractive | Abbe | Focal |
|---|---|---|---|---|---|---|
| No. | nent | Radius | Distance | Index | No. | Length |
| Object | | Infinity | Infinity | | | |
| S1 | | Infinity | 0.095 | | | |
| S2 | 1st Lens | −2.278 | 0.442 | 1.546 | 56.0 | −4.568 |
| S3 | | −27.841 | 0.680 | | | |
| S4 | 2nd Lens | 1.586 | 0.351 | 1.619 | 25.9 | 8.594 |
| S5 | | 2.068 | 0.438 | | | |
| S6 | STOP | Infinity | 0.037 | | | |
| S7 | 3rd Lens | 11.177 | 0.395 | 1.546 | 56.0 | 6.937 |
| S8 | | −5.661 | 0.038 | | | |
| S9 | 4th Lens | 9.120 | 0.465 | 1.546 | 56.0 | 2.588 |
| S10 | | −1.643 | 0.051 | | | |
| S11 | 5th Lens | −3.802 | 0.230 | 1.677 | 19.2 | −4.183 |
| S12 | | 11.498 | 0.567 | | | |
| S13 | 6th Lens | −3.447 | 0.448 | 1.546 | 56.0 | 4.181 |
| S14 | | −1.437 | 0.182 | | | |
| S15 | 7th Lens | 1.508 | 0.600 | 1.667 | 25.9 | −6.624 |
| S16 | | 0.922 | 0.600 | | | |
| S17 | Filter | Infinity | 0.110 | 1.518 | 64.2 | |
| S18 | Imaging | Infinity | 0.472 | | | |
| | Plane | | | | | |

According to the third embodiment of the present disclosure, the first lens 310 may have negative refractive power. In addition, the first lens 310 may have a concave object-side surface S2 and a convex image-side surface S3 in the paraxial region.

The second lens 320 may have positive refractive power. In addition, the second lens 320 may have a convex object-side surface S4 and a concave image-side surface S5 in the paraxial region.

The third lens 330 may have positive refractive power. In addition, both an object-side surface S7 and an image-side surface S8 of the third lens 330 may have a convex shape in the paraxial region.

The fourth lens 340 may have positive refractive power. In addition, both an object-side surface S9 and an image-side surface S10 of the fourth lens 340 may have a convex shape in the paraxial region.

The fifth lens 350 may have negative refractive power. In addition, both an object-side surface S11 and an image-side surface S12 of the fifth lens 350 may have a concave shape in the paraxial region.

The sixth lens 360 may have positive refractive power. In addition, the sixth lens 360 may have a concave object-side surface S13 and a convex image-side surface S14 in the paraxial region.

The seventh lens 370 may have negative refractive power. In addition, the seventh lens 370 may have a convex object-side surface S15 and a concave image-side surface S16 in the paraxial region.

According to the third embodiment of the present disclosure, both the object-side surface and the image-side surface of the first lens (310) to the seventh lens (370) may be aspherical.

The aspherical coefficients of each lens of the optical imaging lens system 300 according to the third embodiment of the present disclosure are as illustrated in Table 6 below.

TABLE 6

| | S2 | S3 | S4 | S5 | S7 |
|---|---|---|---|---|---|
| K | −1.080E+01 | 9.900E+01 | −2.112E+00 | 4.884E+00 | 6.352E+01 |
| A | 1.775E−01 | 2.771E−01 | 1.364E−01 | 3.917E−02 | −7.520E−02 |
| B | −2.080E−01 | −2.079E−01 | −5.277E−01 | −1.514E−01 | −3.049E+00 |
| C | 2.316E−01 | −1.686E−01 | 4.233E+00 | 1.038E+01 | 9.124E+01 |
| D | −2.157E−01 | 1.429E+00 | −1.870E+01 | −2.157E+02 | −1.643E+03 |
| E | 1.581E−01 | −3.876E+00 | 3.343E+01 | 2.470E+03 | 1.935E+04 |
| F | −8.846E−02 | 6.642E+00 | 9.527E+01 | −1.808E+04 | −1.574E+05 |
| G | 3.734E−02 | −7.884E+00 | −7.917E+02 | 9.030E+04 | 9.113E+05 |
| H | −1.181E−02 | 6.664E+00 | 2.507E+03 | −3.170E+05 | −3.809E+06 |
| J | 2.770E−03 | −4.038E+00 | −4.831E+03 | 7.909E+05 | 1.152E+07 |
| L | −4.741E−04 | 1.739E+00 | 6.150E+03 | −1.395E+06 | −2.493E+07 |
| M | 5.746E−05 | −5.188E−01 | −5.219E+03 | 1.701E+06 | 3.764E+07 |
| N | −4.666E−06 | 1.019E−01 | 2.848E+03 | −1.364E+06 | −3.761E+07 |
| O | 2.277E−07 | −1.183E−02 | −9.064E+02 | 6.474E+05 | 2.234E+07 |
| P | −5.045E−09 | 6.147E−04 | 1.280E+02 | −1.378E+05 | −5.967E+06 |

| | S8 | S9 | S10 | S11 | S12 |
|---|---|---|---|---|---|
| K | 2.354E+01 | 4.943E+01 | −9.532E−01 | 4.789E+00 | 9.607E+01 |
| A | −2.574E−01 | −1.718E−01 | 6.641E−01 | 3.972E−01 | −2.875E−02 |
| B | −4.667E+00 | −1.431E+00 | −5.632E+00 | −4.897E+00 | −1.476E+00 |
| C | 8.401E+01 | 2.318E+01 | 4.093E+01 | 3.263E+01 | 1.060E+01 |
| D | −9.644E+02 | −2.190E+02 | −2.757E+02 | −2.039E+02 | −5.807E+01 |
| E | 7.807E+03 | 1.448E+03 | 1.480E+03 | 1.058E+03 | 2.374E+02 |
| F | −4.555E+04 | −6.785E+03 | −5.930E+03 | −4.154E+03 | −7.050E+02 |
| G | 1.942E+05 | 2.287E+04 | 1.744E+04 | 1.200E+04 | 1.521E+03 |
| H | −6.093E+05 | −5.603E+04 | −3.749E+04 | −2.534E+04 | −2.392E+03 |
| J | 1.403E+06 | 9.990E+04 | 5.863E+04 | 3.882E+04 | 2.735E+03 |
| L | −2.338E+06 | −1.283E+05 | −6.583E+04 | −4.64E+04 | −2.247E+03 |
| M | 2.744E+06 | 1.154E+05 | 5.166E+04 | 3.268E+04 | 1.292E+03 |
| N | −2.148E+06 | −6.905E+04 | −2.689E+04 | −1.659E+04 | −4.934E+02 |
| O | 1.006E+06 | 2.466E+04 | 8.344E+03 | 5.016E+03 | 1.124E+02 |
| P | −2.131E+05 | −3.979E+03 | −1.169E+03 | −6.835E+02 | −1.156E+01 |

| | S13 | S14 | S15 | S16 |
|---|---|---|---|---|
| K | 2.714E+00 | −2.054E+00 | −2.864E+00 | −9.828E−01 |
| A | 2.381E−01 | −1.164E−01 | −4.540E−01 | −5.741E−01 |
| B | −6.063E−01 | 4.138E−01 | 5.845E−01 | 6.106E−01 |
| C | 1.787E+00 | −4.409E−01 | −6.292E−01 | −5.637E−01 |
| D | −3.623E+00 | 1.169E−01 | 5.571E−01 | 4.069E−01 |
| E | 4.689E+00 | 7.337E−01 | −3.977E−01 | −2.233E−01 |
| F | −3.296E+00 | −1.677E+00 | 2.239E−01 | 9.239E−02 |
| G | −2.082E−01 | 1.929E+00 | −9.746E−02 | −2.875E−02 |
| H | 3.180E+00 | −1.419E+00 | 3.208E−02 | 6.708E−03 |
| J | −3.683E+00 | 7.183E−01 | −7.807E−03 | −1.164E−03 |
| L | 2.377E+00 | −2.551E−01 | 1.368E−03 | 1.477E−04 |
| M | −9.700E−01 | 6.274E−02 | −1.668E−04 | −1.330E−05 |
| N | 2.487E−01 | −1.018E−02 | 1.334E−05 | 8.044E−07 |
| O | −3.667E−02 | 9.758E−04 | −6.280E−07 | −2.929E−08 |
| P | 2.373E−03 | −4.169E−05 | 1.312E−08 | 4.849E−10 |

### 4th Embodiment

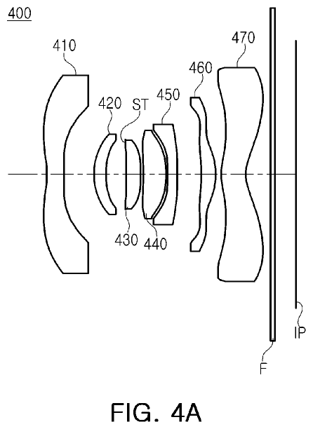

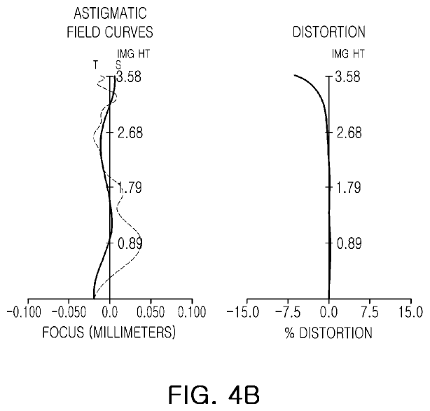

FIG. 4A is a configuration diagram of an optical imaging lens system according to a fourth embodiment of the present disclosure, and FIG. 4B is a graph illustrating aberration characteristics of the optical imaging lens system illustrated in FIG. 4A.

An optical imaging lens system 400 according to the fourth embodiment of the present disclosure may include a first lens 410, a second lens 420, a third lens 430, a fourth lens 440, a fifth lens 450, a sixth lens 460, and a seventh lens 470.

In addition, the optical imaging lens system 400 may include a filter (F) disposed on an image side of the seventh lens 470, an imaging plane (IP) where an image is formed as part of an image sensor, and a stop (ST) disposed between the second lens 420 and the third lens 430 to control the amount of light.

Where f of the optical imaging lens system 400 according to the fourth embodiment of the present disclosure is 2.206 mm, IMH is 7.150 mm, EPD is 1.103 mm, and FOV is 120.070°.

The characteristics of each lens of the optical imaging lens system 400 according to the fourth embodiment of the present disclosure are as illustrated in Table 7 below.

TABLE 7

| Surface | Compo- | Curvature | Thickness/ | Refractive | Abbe | Focal |
|---|---|---|---|---|---|---|
| No. | nent | Radius | Distance | Index | No. | Length |
| Object | | Infinity | Infinity | | | |
| S1 | | Infinity | 0.090 | | | |
| S2 | 1st Lens | −2.142 | 0.418 | 1.546 | 56.0 | −4.789 |
| S3 | | −12.618 | 0.739 | | | |
| S4 | 2nd Lens | 1.581 | 0.293 | 1.619 | 25.9 | 8.620 |
| S5 | | 2.086 | 0.339 | | | |
| S6 | STOP | Infinity | 0.160 | | | |
| S7 | 3rd Lens | 13.127 | 0.354 | 1.546 | 56.0 | 6.575 |
| S8 | | −4.898 | 0.057 | | | |
| S9 | 4th Lens | 12.756 | 0.564 | 1.546 | 56.0 | 2.634 |
| S10 | | −1.597 | 0.038 | | | |
| S11 | 5th Lens | −3.169 | 0.230 | 1.677 | 19.2 | −3.936 |
| S12 | | 17.551 | 0.593 | | | |
| S13 | 6th Lens | −3.258 | 0.354 | 1.546 | 56.0 | 4.252 |
| S14 | | −1.408 | 0.140 | | | |
| S15 | 7th Lens | 1.420 | 0.60 | 1.667 | 25.9 | −6.848 |
| S16 | | 0.882 | 0.600 | | | |
| S17 | Filter | Infinity | 0.110 | 1.518 | 64.2 | |
| S18 | Imaging | Infinity | 0.521 | | | |
| | Plane | | | | | |

According to the fourth embodiment of the present disclosure, the first lens 410 may have negative refractive power. In addition, the first lens 410 may have a concave object-side surface S2 and a convex image-side surface S3 in the paraxial region.

The second lens 420 may have positive refractive power. In addition, the second lens 420 may have a convex object-side surface S4 and a concave image-side surface S5 in the paraxial region.

The third lens 430 may have positive refractive power. In addition, both an object-side surface S7 and an image-side surface S8 of the third lens 430 may have a convex shape in the paraxial region.

The fourth lens 440 may have positive refractive power. In addition, both an object-side surface S9 and an image-side surface S10 of the fourth lens 440 may have a convex shape in the paraxial region.

The fifth lens 450 may have negative refractive power. In addition, both an object-side surface S11 and an image-side surface S12 of the fifth lens 450 may have a concave shape in the paraxial region.

The sixth lens 460 may have positive refractive power. In addition, the sixth lens 460 may have a concave object-side surface S13 and a convex image-side surface S14 in the paraxial region.

The seventh lens 470 may have negative refractive power. In addition, the seventh lens 470 may have a convex object-side surface S15 and a concave image-side surface S16 in the paraxial region.

According to the fourth embodiment of the present disclosure, both the object-side surface and the image-side surface of the first lens 410 to the seventh lens 470 may be aspherical.

The aspherical coefficients of each lens of the optical imaging lens system 400 according to the fourth embodiment of the present disclosure are as illustrated in Table 8 below.

TABLE 8

| | S2 | S3 | S4 | S5 | S7 |
|---|---|---|---|---|---|
| K | −1.197E+01 | −7.210E+01 | −2.268E+00 | 4.888E+00 | 7.180E+01 |
| A | 1.866E−01 | 3.203E−01 | 1.484E−01 | 6.529E−02 | −5.534E−02 |
| B | −2.391E−01 | −3.552E−01 | −8.314E−01 | −8.410E−01 | −3.231E+00 |
| C | 2.981E−01 | 2.911E−01 | 1.008E+01 | 1.887E+01 | 8.056E+01 |
| D | −3.052E−01 | 2.347E−01 | −8.110E+01 | −2.584E+02 | −1.320E+03 |
| E | 2.394E−01 | −1.414E+00 | 4.504E+02 | 2.277E+03 | 1.464E+04 |
| F | −1.407E−01 | 2.732E+00 | −1.776E+03 | −1.365E+04 | −1.138E+05 |
| G | 6.168E−02 | −3.232E+00 | 5.069E+03 | 5.768E+04 | 6.345E+05 |
| H | −2.13E−02 | 2.594E+00 | −1.057E+04 | −1.749E+05 | −2.562E+06 |
| J | 4.855E−03 | −1.452E+00 | 1.612E+04 | 3.820E+05 | 7.498E+06 |
| L | −8.527E−04 | 5.663E−01 | −1.780E+04 | −5.955E+05 | −1.573E+07 |
| M | 1.059E−04 | −1.502E−01 | 1.386E+04 | 6.456E+05 | 2.304E+07 |
| N | −8.794E−06 | 2.568E−02 | −7.230E+03 | −4.620E+05 | −2.237E+07 |
| O | 4.385E−07 | −2.529E−03 | 2.271E+03 | 1.960E+05 | 1.292E+07 |
| P | −9.914E−09 | 1.076E−04 | −3.247E+02 | −3.726E+04 | −3.359E+06 |

| | S8 | S9 | S10 | S11 | S12 |
|---|---|---|---|---|---|
| K | 2.568E+01 | 5.222E+01 | −8.413E−01 | 6.924E+00 | 8.913E+01 |
| A | −3.767E−01 | −3.204E−01 | 1.079E+00 | 8.498E−01 | 3.495E−02 |
| B | −2.015E+00 | 7.364E−01 | −8.822E+00 | −7.637E+00 | −1.463E+00 |
| C | 3.789E+01 | −8.398E+00 | 3.719E+01 | 2.916E+01 | 5.872E+00 |
| D | −4.124E+02 | 7.689E+01 | −7.574E+01 | −4.900E+01 | −1.705E+01 |
| E | 3.147E+03 | −4.179E+02 | −1.212E+02 | −1.259E+02 | 3.995E+01 |
| F | −1.715E+04 | 1.535E+03 | 1.463E+03 | 1.125E+03 | −7.529E+01 |
| G | 6.774E+04 | −3.999E+03 | −5.406E+03 | −3.835E+03 | 1.135E+02 |
| H | −1.957E+05 | 7.502E+03 | 1.210E+04 | 8.142E+03 | −1.357E+02 |
| J | 4.137E+05 | −1.015E+04 | −1.825E+04 | −1.178E+04 | 1.263E+02 |
| L | −6.327E+05 | 9.802E+03 | 1.902E+04 | 1.186E+04 | −8.873E+01 |
| M | 6.815E+05 | −6.587E+03 | −1.353E+04 | −8.197E+03 | 4.514E+01 |
| N | −4.905E+05 | 2.925E+03 | 6.286E+03 | 3.714E+03 | −1.560E+01 |
| O | 2.117E+05 | −7.713E+02 | −1.719E+03 | −9.936E+02 | 3.263E+00 |
| P | −4.144E+04 | 9.144E+01 | 2.101E+02 | 1.190E+02 | −3.111E−01 |

| | S13 | S14 | S15 | S16 |
|---|---|---|---|---|
| K | 2.516E+00 | −2.960E+00 | −2.303E+00 | −9.521E−01 |
| A | 3.422E−01 | −7.769E−02 | −4.670E−01 | −6.066E−01 |
| B | −1.067E+00 | 1.293E−01 | 5.008E−01 | 6.269E−01 |
| C | 2.930E+00 | 1.990E−01 | −3.853E−01 | −5.594E−01 |
| D | −5.709E+00 | −8.093E−01 | 2.426E−01 | 3.924E−01 |
| E | 8.356E+00 | 2.040E+00 | −1.423E−01 | −2.108E−01 |
| F | −9.191E+00 | −3.259E+00 | 7.883E−02 | 8.574E−02 |
| G | 7.459E+00 | 3.307E+00 | −3.737E−02 | −2.629E−02 |
| H | −4.384E+00 | −2.244E+00 | 1.382E−02 | 6.049E−03 |
| J | 1.813E+00 | 1.054E+00 | −3.791E−03 | −1.035E−03 |
| L | −4.984E−01 | −3.464E−01 | 7.486E−04 | 1.259E−04 |
| M | 7.964E−02 | 7.855E−02 | −1.029E−04 | −1.148E−05 |
| N | −4.056E−03 | −1.174E−02 | 9.326E−06 | 6.829E−07 |
| O | −7.072E−04 | 1.043E−03 | −4.999E−07 | −2.440E−08 |
| P | 9.118E−05 | −4.172E−05 | 1.199E−08 | 3.957E−10 |

### 5th Embodiment

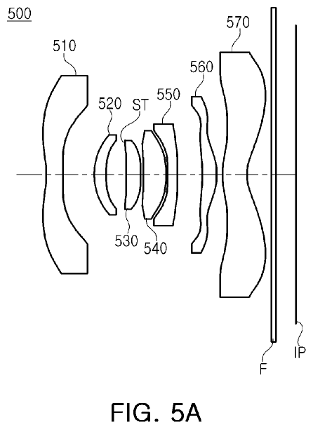

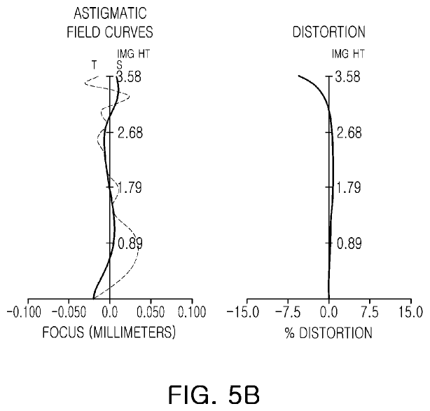

FIG. 5A is a configuration diagram of an optical imaging lens system according to a fifth embodiment of the present disclosure, and FIG. 5B is a graph illustrating aberration characteristics of the optical imaging lens system illustrated in FIG. 5A.

An optical imaging lens system 500 according to the fifth embodiment of the present disclosure may include a first lens 510, a second lens 520, a third lens 530, a fourth lens 540, a fifth lens 550, a sixth lens 560, and a seventh lens 570.

In addition, the optical imaging lens system 500 may include a filter (F) disposed on an image side of the seventh lens 570, an imaging plane (IP) where an image is formed as part of an image sensor, and a stop (ST) disposed between the second lens 520 and the third lens 530 to control the amount of light.

Where f of the optical imaging lens system 500 according to the fifth embodiment of the present disclosure is 2.170 mm, IMH is 7.150 mm, EPD is 1.097 mm, and FOV is 120.080°.

The characteristics of each lens of the optical imaging lens system 500 according to the fifth embodiment of the present disclosure are as illustrated in Table 9 below.

TABLE 9

| Surface | Compo- | Curvature | Thickness/ | Refractive | Abbe | Focal |
|---|---|---|---|---|---|---|
| No. | nent | Radius | Distance | Index | No. | Length |
| Object | | Infinity | Infinity | | | |
| S1 | | Infinity | 0.090 | | | |
| S2 | 1st Lens | −2.158 | 0.408 | 1.546 | 56.0 | −4.839 |
| S3 | | −12.543 | 0.759 | | | |
| S4 | 2nd Lens | 1.581 | 0.290 | 1.619 | 25.9 | 8.714 |
| S5 | | 2.078 | 0.465 | | | |
| S6 | STOP | Infinity | 0.030 | | | |
| S7 | 3rd Lens | 12.872 | 0.357 | 1.546 | 56.0 | 6.485 |
| S8 | | −4.840 | 0.059 | | | |
| S9 | 4th Lens | 13.079 | 0.564 | 1.546 | 56.0 | 2.641 |
| S10 | | −1.597 | 0.038 | | | |
| S11 | 5th Lens | −3.173 | 0.230 | 1.677 | 19.2 | −3.940 |
| S12 | | 17.540 | 0.612 | | | |
| S13 | 6th Lens | −3.255 | 0.354 | 1.546 | 56.0 | 4.258 |
| S14 | | −1.409 | 0.137 | | | |
| S15 | 7th Lens | 1.414 | 0.600 | 1.677 | 25.9 | −7.001 |
| S16 | | 0.883 | 0.600 | | | |
| S17 | Filter | Infinity | 0.110 | 1.518 | 64.2 | |
| S18 | Imaging | Infinity | 0.494 | | | |
| | Plane | | | | | |

According to the fifth embodiment of the present disclosure, the first lens 510 may have negative refractive power. In addition, the first lens 510 may have a concave object-side surface S2 and a convex image-side surface S3 in the paraxial region.

The second lens 520 may have positive refractive power. In addition, the second lens 520 may have a convex object-side surface S4 and a concave image-side surface S5 in the paraxial region.

The third lens 530 may have positive refractive power. In addition, both an object-side surface S7 and an image-side surface S8 of the third lens 530 may have a convex shape in the paraxial region.

The fourth lens 540 may have positive refractive power. In addition, both an object-side surface S9 and an image-side surface S10 of the fourth lens 540 may have a convex shape in the paraxial region.

The fifth lens 550 may have negative refractive power. In addition, both an object-side surface S11 and an image-side surface S12 of the fifth lens 550 may have a concave shape in the paraxial region.

The sixth lens 560 may have positive refractive power. In addition, the sixth lens 560 may have a concave object-side surface S13 and a convex image-side surface S14 in the paraxial region.

The seventh lens 570 may have negative refractive power. In addition, the seventh lens 570 may have a convex object-side surface S15 and a concave image-side surface S16 in the paraxial region.

According to the fifth embodiment of the present disclosure, both the object-side surface and the image-side surface of the first lens 510 to the seventh lens 570 may be aspherical.

The aspherical coefficients of each lens of the optical imaging lens system 500 according to the fifth embodiment of the present disclosure are as illustrated in Table 10 below.

TABLE 10

| | S2 | S3 | S4 | S5 | S7 |
|---|---|---|---|---|---|
| K | −1.194E+01 | −6.019E+01 | −2.275E+00 | 4.882E+00 | 4.890E+01 |
| A | 1.845E−01 | 3.201E−01 | 9.954E−02 | 1.095E−01 | −5.563E−02 |
| B | −2.266E−01 | −4.211E−01 | 3.183E−01 | −2.554E+00 | −3.082E+00 |
| C | 2.705E−01 | 7.688E−01 | −5.977E+00 | 5.530E+01 | 7.582E+01 |
| D | −2.721E−01 | −1.515E+00 | 6.310E+01 | −7.436E+02 | −1.243E+03 |
| E | 2.144E−01 | 2.522E+00 | −4.281E+02 | 6.596E+03 | 1.379E+04 |
| F | −1.284E−01 | −3.188E+00 | 1.990E+03 | −4.033E+04 | −1.071E+05 |
| G | 5.776E−02 | 2.987E+00 | −6.545E+03 | 1.749E+05 | 5.957E+05 |
| H | −1.940E−02 | −2.070E+00 | 1.547E+04 | −5.462E+05 | −2.396E+06 |
| J | 4.823E−03 | 1.061E+00 | −2.636E+04 | 1.231E+06 | 6.977E+06 |
| L | −8.726E−04 | −3.994E−01 | 3.209E+04 | −1.985E+06 | −1.456E+07 |
| M | 1.115E−04 | 1.078E−01 | −2.720E+04 | 2.230E+06 | 2.121E+07 |
| N | −9.528E−06 | −1.987E−02 | 1.523E+04 | −1.658E+06 | −2.047E+07 |
| O | 4.880E−07 | 2.242E−03 | −5.066E+03 | 7.333E+05 | 1.176E+07 |
| P | −1.132E−08 | −1.167E−04 | 7.577E+02 | −1.459E+05 | −3.043E+06 |

| | S8 | S9 | S10 | S11 | S12 |
|---|---|---|---|---|---|
| K | 2.627E+01 | 5.613E+01 | −8.408E−01 | 6.911E+00 | 9.455E+01 |
| A | −4.177E−01 | −3.072E−01 | 1.061E+00 | 8.340E−01 | 1.068E−02 |
| B | −6.327E−01 | 6.579E−01 | −8.397E+00 | −7.373E+00 | −1.215E+00 |
| C | 1.567E+01 | −7.850E+00 | 3.232E+01 | 2.613E+01 | 3.963E+00 |
| D | −1.930E+02 | 7.206E+01 | −4.206E+01 | −2.576E+01 | −6.666E+00 |
| E | 1.704E+03 | −3.870E+02 | −2.769E+02 | −2.456E+02 | 7.207E−01 |
| F | −1.063E+04 | 1.401E+03 | 1.968E+03 | 1.558E+03 | 2.969E+01 |
| G | 4.729E+04 | −3.594E+03 | −6.586E+03 | −4.963E+03 | −8.910E+01 |
| H | −1.518E+05 | 6.631E+03 | 1.411E+04 | 1.027E+04 | 1.486E+02 |
| J | 3.519E+05 | −8.812E+03 | −2.073E+04 | −1.470E+04 | −1.633E+02 |
| L | −5.839E+05 | 8.350E+03 | 2.120E+04 | 1.469E+04 | 1.225E+02 |
| M | 6.757E+05 | −5.497E+03 | −1.484E+04 | −1.009E+04 | −6.218E+01 |
| N | −5.177E+05 | 2.387E+03 | 6.794E+03 | 4.534E+03 | 2.040E+01 |
| O | 2.359E+05 | −6.141E+02 | −1.831E+03 | −1.201E+03 | −3.890E+00 |
| P | −4.836E+04 | 7.082E+01 | 2.202E+02 | 1.419E+02 | 3.256E−01 |

| | S13 | S14 | S15 | S16 |
|---|---|---|---|---|
| K | 2.514E+00 | −3.124E+00 | −2.365E+00 | −9.545E−01 |
| A | 3.234E−01 | −8.829E−02 | −4.475E−01 | −5.834E−01 |
| B | −1.022E+00 | 1.625E−01 | 5.125E−01 | 5.977E−01 |
| C | 2.917E+00 | 1.388E−01 | −4.291E−01 | −5.279E−01 |
| D | −5.760E+00 | −5.591E−01 | 2.809E−01 | 3.645E−01 |
| E | 8.326E+00 | 1.306E+00 | −1.524E−01 | −1.919E−01 |
| F | −8.863E+00 | −2.051E+00 | 7.004E−02 | 7.621E−02 |
| G | 6.828E+00 | 2.066E+00 | −2.665E−02 | −2.275E−02 |
| H | −3.698E+00 | −1.387E+00 | 8.061E−03 | 5.077E−03 |
| J | 1.325E+00 | 6.431E−01 | −1.867E−03 | −8.397E−04 |
| L | −2.620E−01 | −2.081E−01 | 3.202E−04 | 1.012E−04 |
| M | 2.305E−03 | 4.640E−02 | −3.904E−05 | −8.619E−06 |
| N | 1.229E−02 | −6.814E−03 | 3.186E−06 | 4.909E−07 |
| O | −2.723E−03 | 5.940E−04 | −1.554E−07 | −1.675E−08 |
| P | 2.010E−04 | −2.330E−05 | 3.416E−09 | 2.588E−10 |

### 6th Embodiment

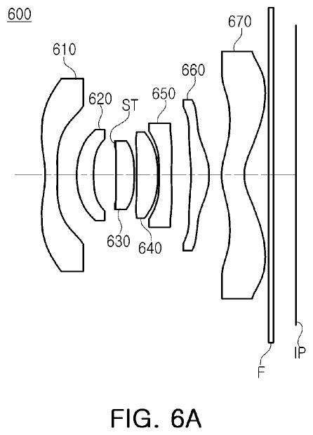

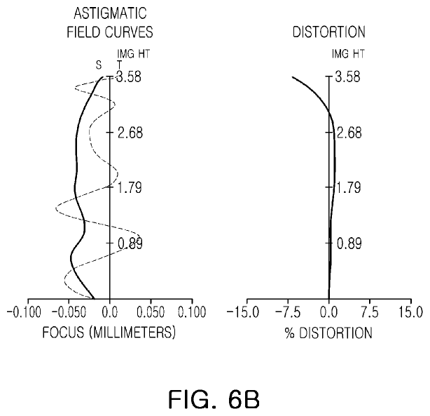

FIG. 6A is a configuration diagram of an optical imaging lens system according to a sixth embodiment of the present disclosure, and FIG. 6B is a graph illustrating aberration characteristics of the optical imaging lens system illustrated in FIG. 6A.

An optical imaging lens system 600 according to the sixth embodiment of the present disclosure may include a first lens 610, a second lens 620, a third lens 630, a fourth lens 640, a fifth lens 650, a sixth lens 660, and a seventh lens 670.

In addition, the optical imaging lens system 600 may include a filter (F) disposed on an image side of the seventh lens 670, an imaging plane (IP) where an image is formed as part of an image sensor, and a stop (ST) disposed between the second lens 620 and the third lens 630 to control the amount of light.

Where f of the optical imaging lens system 600 according to the sixth embodiment of the present disclosure is 2.200 mm, IMH is 7.150 mm, EPD is 1.113 mm, and FOV is 120.000°.

The characteristics of each lens of the optical imaging lens system 600 according to the sixth embodiment of the present disclosure are as illustrated in Table 11 below.

TABLE 11

| Surface | Compo- | Curvature | Thickness/ | Refractive | Abbe | Focal |
|---|---|---|---|---|---|---|
| No. | nent | Radius | Distance | Index | No. | Length |
| Object | | Infinity | Infinity | | | |
| S1 | | Infinity | 0.105 | | | |
| S2 | 1st Lens | −1.734 | 0.300 | 1.546 | 56.0 | −4.294 |
| S3 | | −7.053 | 0.465 | | | |
| S4 | 2nd Lens | 1.841 | 0.410 | 1.619 | 25.9 | 9.061 |
| S5 | | 2.504 | 0.513 | | | |
| S6 | STOP | Infinity | 0.030 | | | |
| S7 | 3rd Lens | 12.363 | 0.477 | 1.546 | 56.0 | 6.063 |
| S8 | | −4.467 | 0.055 | | | |
| S9 | 4th Lens | 9.528 | 0.520 | 1.546 | 56.0 | 2.944 |
| S10 | | −1.898 | 0.031 | | | |
| S11 | 5th Lens | −4.790 | 0.300 | 1.677 | 19.2 | −4.222 |
| S12 | | 7.319 | 0.472 | | | |
| S13 | 6th Lens | −3.312 | 0.440 | 1.546 | 56.0 | 4.148 |
| S14 | | −1.409 | 0.308 | | | |
| S15 | 7th Lens | 1.236 | 0.548 | 1.667 | 25.9 | −10.348 |
| S16 | | 0.857 | 0.600 | | | |
| S17 | Filter | Infinity | 0.110 | 1.518 | 64.2 | |
| S18 | Imaging | Infinity | 0.548 | | | |
| | Plane | | | | | |

According to the sixth embodiment of the present disclosure, the first lens 610 may have negative refractive power. In addition, the first lens 610 may have a concave object-side surface S2 and a convex image-side surface S3 in the paraxial region.

The second lens 620 may have positive refractive power. In addition, the second lens 620 may have a convex object-side surface S4 and a concave image-side surface S5 in the paraxial region.

The third lens 630 may have positive refractive power. In addition, both an object-side surface S7 and an image-side surface S8 of the third lens 630 may have a convex shape in the paraxial region.

The fourth lens 640 may have positive refractive power. In addition, both an object-side surface S9 and an image-side surface S10 of the fourth lens 640 may have a convex shape in the paraxial region.

The fifth lens 650 may have negative refractive power. In addition, both an object-side surface S11 and an image-side surface S12 of the fifth lens 650 may have a concave shape in the paraxial region.

The sixth lens 660 may have positive refractive power. In addition, the sixth lens 660 may have a concave object-side surface S13 and a convex image-side surface S14 in the paraxial region.

The seventh lens 670 may have negative refractive power. In addition, the seventh lens 670 may have a convex object-side surface S15 and a concave image-side surface S16 in the paraxial region.

According to the sixth embodiment of the present disclosure, both the object-side surface and the image-side surface of the first lens 610 to the seventh lens 670 may be aspherical.

The aspherical coefficients of each lens of the optical imaging lens system 600 according to the sixth embodiment of the present disclosure are as illustrated in Table 12 below.

TABLE 12

| | S2 | S3 | S4 | S5 | S7 |
|---|---|---|---|---|---|
| K | −1.302E+01 | −2.343E+01 | −1.635E+00 | 6.722E+00 | −7.397E+01 |
| A | 2.003E−01 | 4.193E−01 | 1.944E−01 | 7.190E−02 | −3.473E−01 |
| B | −2.266E−01 | −5.324E−01 | −2.161E+00 | −2.685E−01 | 1.683E+01 |
| C | 2.238E−01 | 7.654E−01 | 1.925E+01 | 7.113E+00 | −5.240E+02 |
| D | −1.912E−01 | −1.543E+00 | −1.068E+02 | −1.192E+02 | 9.872E+03 |
| E | 1.429E−01 | 3.158E+00 | 3.952E+02 | 1.267E+03 | −1.221E+05 |
| F | −8.964E−02 | −4.779E+00 | −1.001E+03 | −8.649E+03 | 1.039E+06 |
| G | 4.475−02 | 5.055E+00 | 1.751E+03 | 3.970E+04 | −6.274E+06 |
| H | −1.709E−02 | −3.760E+00 | −2.078E+03 | −1.264E+05 | 2.726E+07 |
| J | 4.859E−03 | 1.980E+00 | 1.567E+03 | 2.826E+05 | −8.550E+07 |
| L | −1.004E−03 | −7.339E−01 | −5.832E+02 | −4.431E+05 | 1.919E+08 |
| M | 1.459E−04 | 1.869E−01 | −9.910E+01 | 4.769E+05 | −3.006E+08 |
| N | −1.411E−05 | −3.103E−02 | 2.172E+02 | −3.356E+05 | 3.118E+08 |
| O | 8.141E−07 | 3.014E−03 | −9.389E+01 | 1.391E+05 | −1.926E+08 |
| P | −2.120E−08 | −1.293E−04 | 1.463E+01 | −2.576E+04 | 5.357E+07 |

| | S8 | S9 | S10 | S11 | S12 |
|---|---|---|---|---|---|
| K | 2.227E+01 | 8.074E+01 | −6.217E−01 | 1.036E+01 | 2.647E+01 |
| A | −1.699E−01 | −1.858E−01 | 8.188E−01 | 5.305E−01 | 2.673E−02 |
| B | −3.550E+00 | 2.365E−01 | −6.671E+00 | −5.068E+00 | −1.474E+00 |
| C | 7.465E+01 | −6.018E+00 | 3.004E+01 | 1.544E+01 | 7.493E+00 |
| D | −1.037E+03 | 6.445E+01 | −7.274E+01 | 2.199E+01 | −2.822E+01 |
| E | 9.777E+03 | −3.866E+02 | −1.522E+01 | −4.319E+02 | 8.399E+01 |
| F | −6.352E+04 | 1.530E+03 | 8.134E+02 | 2.109E+03 | −1.939E+02 |
| G | 2.903E+05 | −4.268E+03 | −3.235E+03 | −6.152E+03 | 3.401E+02 |
| H | −9.466E+05 | 8.655E+03 | 7.331E+03 | 1.214E+04 | −4.457E+02 |
| J | 2.213E+06 | −1.288E+04 | −1.102E+04 | −1.681E+04 | 4.302E+02 |
| L | −3.681E+06 | 1.394E+04 | 1.140E+04 | 1.642E+04 | −3.001E+02 |
| M | 4.253E+06 | −1.069E+04 | −8.092E+03 | −1.112E+04 | 1.466E+02 |
| N | −3.244E+06 | 5.510E+03 | 3.788E+03 | 4.978E+03 | −4.753E+01 |
| O | 1.469E+06 | −1.711E+03 | −1.060E+03 | −1.328E+03 | 9.167E+00 |
| P | −2.992E+05 | 2.422E+02 | 1.348E+02 | 1.599E+02 | −7.954E−01 |

| | S13 | S14 | S15 | S16 |
|---|---|---|---|---|
| K | 2.721E+00 | −2.530E+00 | −3.338E+00 | −9.545E−01 |
| A | 2.990E−01 | −6.383E−02 | −2.454E−01 | −5.834E−01 |
| B | −7.088E−01 | 1.909E−01 | 9.425E−02 | 5.977E−01 |
| C | 1.311E+00 | −2.678E−01 | 2.134E−01 | −5.279E−01 |
| D | −5.053E−01 | 7.602E−01 | −4.398E−01 | 3.645E−01 |
| E | −3.678E+00 | −1.540E+00 | 4.228E−01 | −1.919E−01 |
| F | 1.024E+01 | 2.073E+00 | −2.585−01 | 7.621E−02 |
| G | −1.457E+01 | −1.975E+00 | 1.093E−01 | −2.275E−02 |
| H | 1.340E+01 | 1.351E+00 | −3.305E−02 | 5.077E−03 |
| J | −8.460E+00 | −6.610E−01 | 7.231E−03 | −8.397E−04 |
| L | 3.715E+00 | 2.285E−01 | −1.128E−03 | 1.012E−04 |
| M | −1.118E+00 | −5.441E−02 | 1.234E−04 | −8.619E−06 |
| N | 2.203E−01 | 8.478E−03 | −8.955E−06 | 4.909E−07 |
| O | −2.560E−02 | −7.780E−04 | 3.874E−07 | −1.675E−08 |
| P | 1.330E−03 | 3.186E−05 | −7.561E−09 | 2.588E−10 |

### 7th Embodiment

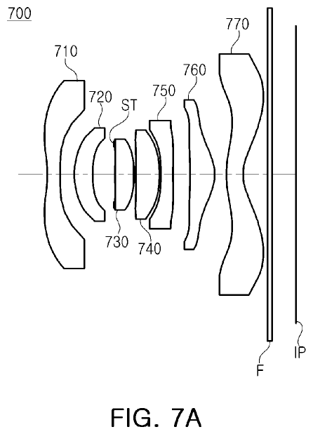

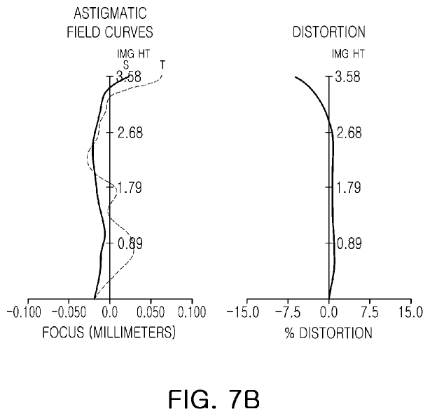

FIG. 7A is a configuration diagram of an optical imaging lens system according to a seventh embodiment of the present disclosure, and FIG. 7B is a graph illustrating aberration characteristics of the optical imaging lens system illustrated in FIG. 7A.

An optical imaging lens system 700 according to the seventh embodiment of the present disclosure may include a first lens 710, a second lens 720, a third lens 730, a fourth lens 740, a fifth lens 750, a sixth lens 760, and a seventh lens 770.

In addition, the optical imaging lens system 700 may include a filter (F) disposed on an image side of the seventh lens 770, an imaging plane (IP) where an image is formed as part of an image sensor, and a stop (ST) disposed between the second lens 720 and the third lens 730 to control the amount of light.

Where f of the optical imaging lens system 700 according to the seventh embodiment of the present disclosure is 2.182 mm, IMH is 7.150 mm, EPD is 1.103 mm, and FOV is 120.080°.

The characteristics of each lens of the optical imaging lens system 700 according to the seventh embodiment of the present disclosure are as illustrated in Table 13 below.

TABLE 13

| Surface | Compo- | Curvature | Thickness/ | Refractive | Abbe | Focal |
|---|---|---|---|---|---|---|
| No. | nent | Radius | Distance | Index | No. | Length |
| Object | | Infinity | Infinity | | | |
| S1 | | Infinity | 0.090 | | | |
| S2 | 1st Lens | −1.864 | 0.310 | 1.546 | 56.0 | −3.926 |
| S3 | | −15.051 | 0.351 | | | |
| S4 | 2nd Lens | 1.773 | 0.446 | 1.619 | 25.9 | 8.047 |
| S5 | | 2.486 | 0.519 | | | |
| S6 | STOP | Infinity | 0.030 | | | |
| S7 | 3rd Lens | 11.612 | 0.455 | 1.546 | 56.0 | 5.849 |
| S8 | | −4.348 | 0.053 | | | |
| S9 | 4th Lens | 10.278 | 0.579 | 1.546 | 56.0 | 3.328 |
| S10 | | −2.165 | 0.030 | | | |
| S11 | 5th Lens | −5.091 | 0.301 | 1.677 | 19.2 | −4.514 |
| S12 | | 7.884 | 0.420 | | | |
| S13 | 6th Lens | −6.100 | 0.598 | 1.546 | 56.0 | 1.968 |
| S14 | | −0.946 | 0.291 | | | |
| S15 | 7th Lens | 2.797 | 0.407 | 1.667 | 25.9 | −2.576 |
| S16 | | 0.913 | 0.600 | | | |
| S17 | Filter | Infinity | 0.110 | 1.518 | 64.2 | |
| S18 | Imaging | Infinity | 0.587 | | | |
| | Plane | | | | | |

According to the seventh embodiment of the present disclosure, the first lens 710 may have negative refractive power. In addition, the first lens 710 may have a concave object-side surface S2 and a convex image-side surface S3 in the paraxial region.

The second lens 720 may have positive refractive power. In addition, the second lens 720 may have a convex object-side surface S4 and a concave image-side surface S5 in the paraxial region.

The third lens 730 may have positive refractive power. In addition, both an object-side surface S7 and an image-side surface S8 of the third lens 730 may have a convex shape in the paraxial region.

The fourth lens 740 may have positive refractive power. In addition, both an object-side surface S9 and an image-side surface S10 of the fourth lens 740 may have a convex shape in the paraxial region.

The fifth lens 750 may have negative refractive power. In addition, both an object-side surface S11 and an image-side surface S12 of the fifth lens 750 may have a concave shape in the paraxial region.

The sixth lens 760 may have positive refractive power. In addition, the sixth lens 760 may have a concave object-side surface S13 and a convex image-side surface S14 in the paraxial region.

The seventh lens 770 may have negative refractive power. In addition, the seventh lens 770 may have a convex object-side surface S15 and a concave image-side surface S16 in the paraxial region.

According to the seventh embodiment of the present disclosure, both the object-side surface and the image-side surface of the first lens 710 to the seventh lens 770 may be aspherical.

The aspherical coefficients of each lens of the optical imaging lens system 700 according to the seventh embodiment of the present disclosure are as illustrated in Table 14 below.

TABLE 14

| | S2 | S3 | S4 | S5 | S7 |
|---|---|---|---|---|---|
| K | −1.813E+01 | −5.226E+00 | −1.667E+00 | 6.622E+00 | −7.197E+01 |
| A | 1.874E−01 | 4.632E−01 | 1.449E−01 | 8.144E−02 | −2.108E−01 |
| B | −2.078E−01 | −6.742E−01 | −1.304E+00 | 5.739E−01 | 1.064E+01 |
| C | 1.867E−01 | 8.267E−01 | 1.179E+01 | −2.352E+01 | −3.314E+02 |
| D | −1.345E−01 | −9.516E−01 | −7.179E+01 | 3.484E+02 | 6.077E+03 |
| E | 8.519E−02 | 1.278E+00 | 3.026E+02 | −2.961E+03 | −7.258E+04 |
| F | −5.007E−02 | −1.720E+00 | −8.998E+02 | 1.652E+04 | 5.956E+05 |
| G | 2.607E−02 | 1.849E+00 | 1.925E+03 | −6.400E+04 | −3.464E+06 |
| H | −1.098E−02 | −1.466E+00 | −2.997E+03 | 1.765E+05 | 1.452E+07 |
| J | 3.494E−03 | 8.446E−01 | 3.396E+03 | −3.493E+05 | −4.404E+07 |
| L | −8.063E−04 | −3.526E−01 | −2.769E+03 | 4.929E+05 | 9.579E+07 |
| M | 1.298E−04 | 1.049E−01 | 1.581E+03 | −4.840E+05 | −1.457E+08 |
| N | −1.377E−05 | −2.126E−02 | −5.997E+02 | 3.142E+05 | 1.472E+08 |
| O | 8.653E−07 | 2.641E−03 | 1.354E+02 | −1.211E+05 | −8.879E+07 |
| P | −2.436E−08 | −1.517E−04 | −1.377E+01 | 2.098E+04 | 2.418E+07 |

| | S8 | S9 | S10 | S11 | S12 |
|---|---|---|---|---|---|
| K | 2.111E+01 | 9.147E+01 | 7.716E−03 | 1.586E+01 | 2.388E+01 |
| A | −2.373E−01 | −1.800E−01 | 6.907E−01 | 4.063E−01 | −5.393E−02 |
| B | −1.541E+00 | −1.077E+00 | −7.126E+00 | −4.754E+00 | −5.252E−01 |
| C | 2.148E+01 | 1.399E+01 | 4.979E+01 | 2.718E+01 | 1.770E+00 |
| D | −1.450E+02 | −9.979E+01 | −2.630E+02 | −1.140E+02 | −2.732E+00 |
| E | 5.071E+02 | 4.969E+02 | 9.942E+02 | 3.312E+02 | −2.312E+00 |
| F | −9.588E+03 | −1.799E+03 | −2.655E+03 | −6.076E+02 | 2.379E+01 |
| G | 5.281E+04 | 4.821E+03 | 4.995E+03 | 5.298E+02 | −6.314E+01 |
| H | −1.604E+05 | −9.605E+03 | −6.545E+03 | 3.864E+02 | 9.911E+01 |
| J | 3.132E+05 | 1.414E+04 | 5.753E+03 | −1.869E+03 | −1.035E+02 |
| L | −4.029E+05 | −1.511E+04 | −3.056E+03 | 2.765E+03 | 7.411E+01 |
| M | 3.310E+05 | 1.137E+04 | 6.176E+02 | −2.343E+03 | −3.604E+01 |
| N | −1.578E+05 | −5.694E+03 | 2.815E+02 | 1.203E+03 | 1.140E+01 |
| O | 3.324E+04 | 1.700E+03 | −2.039E+02 | −3.496E+02 | −2.120E+00 |
| P | | −2.284E+02 | 3.793E+01 | 4.427E+01 | 1.757E−01 |

| | S13 | S14 | S15 | S16 |
|---|---|---|---|---|
| K | 1.147E+01 | −3.800E+00 | −2.705E+00 | −9.545E−01 |
| A | 8.613E−02 | 4.796E−02 | 1.741E−01 | −5.834E−01 |
| B | 3.354E−01 | −1.401⊏−01 | −7.974E−01 | 5.977E−01 |
| C | −2.212E+00 | 3.092E−01 | 1.413E+00 | −5.279E−01 |
| D | 7.018E+00 | −3.322E−01 | −1.621E+00 | 3.645E−01 |
| E | −1.435E+01 | 3.615E−01 | 1.306E+00 | −1.919E−01 |
| F | 2.035E+01 | −4.925E−01 | −7.626E−01 | 7.621E−02 |
| G | −2.072E+01 | 5.440E−01 | 3.277E−01 | −2.275E−02 |
| H | 1.538E+01 | −4.079E−01 | −1.040E−01 | 5.077E−03 |
| J | −8.331E+00 | 2.047E−01 | 2.429E−02 | −8.397E−04 |
| L | 3.258E+00 | −6.885E−02 | −4.108E−03 | 1.012E−04 |
| M | −8.946E−01 | 1.525E−02 | 4.887E−04 | −8.619E−06 |
| N | 1.633E−01 | −2.117E−03 | −3.872E−05 | 4.909E−07 |
| O | −1.778E−02 | 1.647E−04 | 1.832E−06 | −1.675E−08 |
| P | 8.718E−04 | −5.344E−06 | −3.915E−08 | 2.588E−10 |

### 8th Embodiment

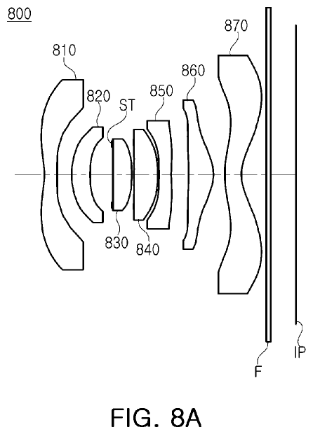

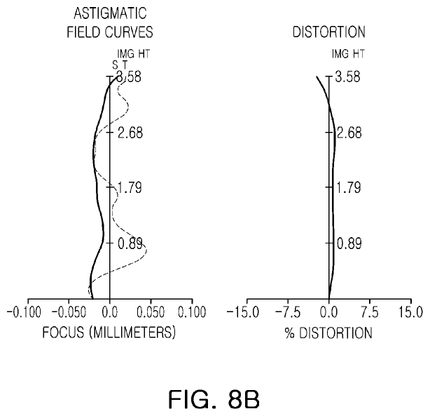

FIG. 8A is a configuration diagram of an optical imaging lens system according to an eighth embodiment of the present disclosure, and FIG. 8B is a graph illustrating aberration characteristics of the optical imaging lens system illustrated in FIG. 8A.

An optical imaging lens system 800 according to the eighth embodiment of the present disclosure may include a first lens 810, a second lens 820, a third lens 830, a fourth lens 840, a fifth lens 850, a sixth lens 860, and a seventh lens 870.

In addition, the optical imaging lens system 800 may include a filter (F) disposed on an image side of the eighth lens 870, an imaging plane (IP) where an image is formed as part of an image sensor, and a stop (ST) disposed between the second lens 820 and the third lens 830 to control the amount of light.

Where f of the optical imaging lens system 800 according to the eighth embodiment of the present disclosure is 2.201 mm, IMH is 7.150 mm, EPD is 1.113 mm, and FOV is 117.650°.

The characteristics of each lens of the optical imaging lens system 800 according to the eighth embodiment of the present disclosure are as illustrated in Table 15 below.

TABLE 15

| Surface | Compo- | Curvature | Thickness/ | Refractive | Abbe | Focal |
|---|---|---|---|---|---|---|
| No. | nent | Radius | Distance | Index | No. | Length |
| Object | | Infinity | Infinity | | | |
| S1 | | Infinity | 0.091 | | | |
| S2 | 1st Lens | −1.862 | 0.309 | 1.546 | 56.0 | −3.948 |
| S3 | | −14.396 | 0.358 | | | |
| S4 | 2nd Lens | 1.781 | 0.448 | 1.619 | 25.9 | 8.148 |
| S5 | | 2.485 | 0.523 | | | |
| S6 | STOP | Infinity | 0.030 | | | |
| S7 | 3rd Lens | 11.607 | 0.455 | 1.546 | 56.0 | 5.849 |
| S8 | | −4.348 | 0.059 | | | |
| S9 | 4th Lens | 10.278 | 0.575 | 1.546 | 56.0 | 3.330 |
| S10 | | −2.167 | 0.031 | | | |
| S11 | 5th Lens | −5.086 | 0.300 | 1.677 | 19.2 | −4.533 |
| S12 | | 7.980 | 0.424 | | | |
| S13 | 6th Lens | −6.042 | 0.592 | 1.546 | 56.0 | 1.976 |
| S14 | | −0.948 | 0.285 | | | |
| S15 | 7th Lens | 2.787 | 0.400 | 1.667 | 25.9 | −2.584 |
| S16 | | 0.914 | 0.600 | | | |
| S17 | Filter | Infinity | 0.110 | 1.518 | 64.2 | |
| S18 | Imaging | Infinity | 0.616 | | | |
| | Plane | | | | | |

According to the eighth embodiment of the present disclosure, the first lens 810 may have negative refractive power. In addition, the first lens 810 may have a concave object-side surface S2 and a convex image-side surface S3 in the paraxial region.

The second lens 820 may have positive refractive power. In addition, the second lens 820 may have a convex object-side surface S4 and a concave image-side surface S5 in the paraxial region.

The third lens 830 may have positive refractive power. In addition, both an object-side surface S7 and an image-side surface S8 of the third lens 830 may have a convex shape in the paraxial region.

The fourth lens 840 may have positive refractive power. In addition, both an object-side surface S9 and an image-side surface S10 of the fourth lens 840 may have a convex shape in the paraxial region.

The fifth lens 850 may have negative refractive power. In addition, both an object-side surface S11 and an image-side surface S12 of the fifth lens 850 may have a concave shape in the paraxial region.

The sixth lens 860 may have positive refractive power. In addition, the sixth lens 860 may have a concave object-side surface S13 and a convex image-side surface S14 in the paraxial region.

The seventh lens 870 may have negative refractive power. In addition, the seventh lens 870 may have a convex object-side surface S15 and a concave image-side surface S16 in the paraxial region.

According to the eighth embodiment of the present disclosure, both the object-side surface and the image-side surface of the first lens 810 to the seventh lens 870 may be aspherical.

The aspherical coefficients of each lens of the optical imaging lens system 800 according to the eighth embodiment of the present disclosure are as illustrated in Table 16 below.

TABLE 16

| | S2 | S3 | S4 | S5 | S7 |
|---|---|---|---|---|---|
| K | −1.826E+01 | −3.129E+00 | −1.655E+00 | 6.622E+00 | −9.695E+01 |
| A | 1.936E−01 | 4.724E−01 | 1.673E−01 | 1.339E−01 | −1.489E−01 |
| B | −2.308E−01 | −6.546E−01 | −1.766E+00 | −1.239E+00 | 7.246E+00 |
| C | 2.353E−01 | 4.214E−01 | 1.682E+01 | 9.811E+00 | −2.391E+02 |
| D | −1.954E−01 | 1.102E+00 | −1.056E+02 | −3.492E+01 | 4.529E+03 |
| E | 1.331E−01 | −4.418E+00 | 4.540E+02 | 8.457E+00 | −5.527E+04 |
| F | −7.354E−02 | 8.390E+00 | −1.372E+03 | 4.032E+02 | 4.605E+05 |
| G | 3.236E−02 | −1.040E+01 | 2.977E+03 | −1.263E+03 | −2.710E+06 |
| H | −1.109E−02 | 8.998E+00 | −4.693E+03 | −3.851E+02 | 1.146E+07 |
| J | 2.897E−03 | −5.521E+00 | 5.380E+03 | 1.203E+04 | −3.501E+07 |
| L | −5.621E−04 | 2.395E+00 | −4.434E+03 | −3.624E+04 | 7.657E+07 |
| M | 7.825E−05 | −7.173E−01 | 2.559E+03 | 5.685E+04 | −1.170E+08 |
| N | −7.375E−06 | 1.411E−01 | −9.803E+02 | −5.197E+04 | 1.185E+08 |
| O | 4.213E−07 | −1.639E−02 | 2.237E+02 | 2.630E+04 | −7.160E+07 |
| P | −1.101E−08 | 8.512E−04 | −2.300E+01 | −5.728E+03 | 1.951E+07 |

| | S8 | S9 | S10 | S11 | S12 |
|---|---|---|---|---|---|
| K | 2.110E+01 | 9.147E+01 | 5.024E−03 | 1.585E+01 | 2.383E+01 |
| A | −2.371E−01 | −2.216E−01 | 6.058E−01 | 3.611E−01 | −5.355E−02 |
| B | −1.258E+00 | 1.650E−02 | −4.596E+00 | −3.377E+00 | −5.222E−01 |
| C | 1.714E+01 | 9.918E−01 | 1.775E+01 | 1.042E+01 | 1.524E+00 |
| D | −1.116E+02 | −7.164E+00 | −3.014E+01 | 1.248E+00 | −8.521E−01 |
| E | 3.383E+02 | 5.434E+01 | −9.889E+01 | −1.786E+02 | −9.826E+00 |
| F | 6.172E+02 | −2.992E+02 | 8.623E+02 | 9.388E+02 | 4.349E+01 |
| G | −1.124E+04 | 1.101E+03 | −3.013E+03 | −2.793E+03 | −9.951E+01 |
| H | 5.587E+04 | −2.747E+03 | 6.562E+03 | 5.521E+03 | 1.475E+02 |
| J | −1.634E+05 | 4.739E+03 | −9.706E+03 | −7.582E+03 | −1.500E+02 |
| L | 3.125E+05 | −5.665E+03 | 9.951E+03 | 7.289E+03 | 1.060E+02 |
| M | −3.957E+05 | 4.616E+03 | −6.988E+03 | −4.822E+03 | −5.127E+01 |
| N | 3.210E+05 | −2.447E+03 | 3.213E+03 | 2.093E+03 | 1.622E+01 |
| O | −1.514E+05 | 7.615E+02 | −8.727E+02 | −5.367E+02 | −3.023E+00 |
| P | 3.158E+04 | −1.055E+02 | 1.062E+02 | 6.165E+01 | 2.520E−01 |

| | S13 | S14 | S15 | S16 |
|---|---|---|---|---|
| K | 1.163E+01 | −3.818E+00 | −2.705E+00 | −9.545E−01 |
| A | 9.501E−02 | 1.964E−02 | 1.741E−01 | −5.834E−01 |
| B | 2.929E−01 | 9.919E−02 | −7.974E−01 | 5.977E−01 |
| C | −2.132E+00 | −6.125E−01 | 1.413E+00 | −5.279E−01 |
| D | 7.042E+00 | 1.884E+00 | −1.621E+00 | 3.645E−01 |
| E | −1.490E+01 | −3.306E+00 | 1.306E+00 | −1.919E−01 |
| F | 2.191E+01 | 3.813E+00 | −7.626E−01 | 7.621E−02 |
| G | −2.317E+01 | −3.079E+00 | 3.277E−01 | −2.275E−02 |
| H | 1.787E+01 | 1.785E+00 | −1.040E−01 | 5.077E−03 |
| J | −1.008E+01 | −7.489E−01 | 2.429E−02 | −8.397E−04 |
| L | 4.109E+00 | 2.258E−01 | −4.108E−03 | 1.012E−04 |
| M | −1.179E+00 | −4.790E−02 | 4.887E−04 | −8.619E−06 |
| N | 2.255E−01 | 6.811E−03 | −3.872E−05 | 4.909E−07 |
| O | −2.580E−02 | −5.852E−04 | 1.832E−06 | −1.675E−08 |
| P | 1.333E−03 | 2.304E−05 | −3.915E−08 | 2.588E−10 |

Conditional expression data according to embodiments of the present disclosure are as illustrated in Table 17 below.

TABLE 17

| Conditional | 1st | 2nd | 3rd | 4th |
|---|---|---|---|---|
| Expression | Embodiment | Embodiment | Embodiment | Embodiment |
| (TTL/IMH)*Fno | 1.691 | 1.692 | 1.691 | 1.709 |
| f/EPD | 1.980 | 1.980 | 1.980 | 2.000 |
| v1-v2 | 30.100 | 30.100 | 30.100 | 30.100 |
| v1-v5 | 36.800 | 36.800 | 36.800 | 36.800 |
| v1-v7 | 18.598 | 18.598 | 30.100 | 30.100 |
| TTL/IMH | 0.854 | 0.854 | 0.854 | 0.855 |
| FOV/f | 54.236 | 54.049 | 54.996 | 54.429 |
| L6R1/CT6 | −6.819 | −7.113 | −7.702 | −9.209 |
| L6R1/L6R2 | 2.403 | 2.388 | 2.399 | 2.314 |
| L1R1/L2R2 | 2.906 | 2.875 | 2.975 | 3.183 |
| Conditional | 5th | 6th | 7th | 8th |
| Expression | Embodiment | Embodiment | Embodiment | Embodiment |
| (TTL/IMH)*Fno | 1.689 | 1.686 | 1.683 | 1.691 |
| f/EPD | 1.977 | 1.977 | 1.977 | 1.977 |
| v1-v2 | 30.100 | 30.100 | 30.100 | 30.100 |
| v1-v5 | 36.800 | 36.800 | 36.800 | 36.800 |
| v1-v7 | 30.100 | 30.100 | 30.100 | 30.100 |
| TTL/IMH | 0.854 | 0.853 | 0.851 | 0.855 |
| FOV/f | 55.339 | 54.536 | 55.042 | 53.465 |
| L6R1/CT6 | −9.206 | −7.522 | −10.197 | −10.201 |
| L6R1/L6R2 | 2.311 | 2.351 | 6.451 | 6.377 |
| L1R1/L2R2 | 2.917 | 2.706 | 2.597 | 2.573 |

An ultra-wide-angle optical imaging lens system according to embodiments of the present disclosure may capture high-resolution and bright images while achieving miniaturization.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging lens system, comprising:
a first lens, a second lens, a third lens, a fourth lens, a fifth lens, a sixth lens, and a seventh lens, arranged in order from an object side,
wherein the first lens has a convex image-side surface, and the sixth lens has a concave object-side surface, and
wherein the following conditional expression is satisfied:
$$( TTL / IMH ) ⋆ Fno < 1.71 ,$$
where TTL is a distance on an optical axis from an object-side surface of the first lens to an imaging plane and IMH is a diagonal length of the imaging plane.

2. The optical imaging lens system of claim 1, wherein the sixth lens has a convex image-side surface.

3. The optical imaging lens system of claim 1, wherein the following conditional expression is satisfied:
$$L 6 R 1 / CT 6 < - 6 ,$$
where L6R1 is a radius of curvature of the object-side surface of the sixth lens, and CT6 is a thickness on the optical axis of the sixth lens.

4. The optical imaging lens system of claim 1, wherein the following conditional expression is satisfied:
$$2 < L 6 R 1 / L 6 R 2 ,$$
where L6R1 is a radius of curvature of the object-side surface of the sixth lens, and L6R2 is a radius of curvature of an image-side surface of the sixth lens.

5. The optical imaging lens system of claim 1, wherein the fourth lens has a convex object-side surface.

6. The optical imaging lens system of claim 1, wherein the following conditional expression is satisfied:
$$15 < v 1 - v 2 < 40 ,$$
where v1 is an Abbe number of the first lens, and v2 is an Abbe number of the second lens.

7. The optical imaging lens system of claim 1, wherein the following conditional expression is satisfied:
$$0 < v 1 - v 7 < 40 ,$$
where v1 is an Abbe number of the first lens, and v7 is an Abbe number of the seventh lens.

8. The optical imaging lens system of claim 1, wherein the fifth lens has negative refractive power and a concave image-side surface.

9. The optical imaging lens system of claim 1, wherein the sixth lens has positive refractive power, and the seventh lens has negative refractive power.

10. An optical imaging lens system comprising:
a first lens having negative refractive power and a convex image-side surface;
a second lens having positive refractive power;
a third lens having positive refractive power;
a fourth lens having positive refractive power;
a fifth lens having refractive power;
a sixth lens having positive refractive power; and
a seventh lens having refractive power,
wherein the first lens to the seventh lens are arranged in order from an object side, and
wherein the following conditional expression is satisfied:
$$L 6 R 1 / CT 6 < - 6 ,$$
where L6R1 is a radius of curvature of an object-side surface of the sixth lens, and CT6 is a thickness on an optical axis of the sixth lens.

11. The optical imaging lens system of claim 10, wherein the following conditional expression is satisfied:
$$2 < L 6 R 1 / L 6 R 2 ,$$
where L6R2 is a radius of curvature of an image-side surface of the sixth lens.

12. The optical imaging lens system of claim 10, wherein the fifth lens and the seventh lens each have negative refractive power.

13. The optical imaging lens system of claim 10, wherein the following conditional expression is satisfied:
$$TTL / IMH < 0.86 ,$$
where TTL is a distance on the optical axis from an object-side surface of the first lens to an imaging plane, and IMH is a diagonal length of the imaging plane.

14. The optical imaging lens system of claim 10, wherein the following conditional expression is satisfied:
$$50 < F O V / f ( unit : ° / mm )$$
where FOV is a field of view of the optical imaging lens system, and f is a total focal length of the optical imaging lens system.

15. The optical imaging lens system of claim 10, wherein the following conditional expression is satisfied:
$$25 < v 1 - v 5 < 45 ,$$
where v1 is an Abbe number of the first lens, and v5 is an Abbe number of the fifth lens.

16. The optical imaging lens system of claim 10, wherein the fifth lens has a concave image-side surface.
